(19) United States
(12) Patent Application Publication
(10) Pub. No.: US 2002/0191943 A1
(43) Pub. Date: Dec. 19, 2002

(54) Venting optical microbench

(76) Inventors: William T. Hughes, Christiansburg, VA (US); Gary E. Zacherl, Christiansburg, VA (US)

Correspondence Address: Joseph P. Quinn, Esq., Brown Rudnick Berlack Israels LLP, One Financial Center, Boston, MA, 02111, US

(21) Appl. No.: 10/135,192

(22) Filed: Apr. 29, 2002

Related U.S. Application Data
(60) Provisional application No. 60/288,231, filed on May 1, 2001.

(51) Int. Cl. G02B 6/00

(52) U.S. Cl. 385/137

(57) ABSTRACT

An optical microbench for retaining an optical element is provided. The microbench has a predetermined thickness with a first side and a second generally opposite side. The first side includes at least one fiber retaining groove having a first depth sufficient to retain the optical element. The second side includes at least one vent groove having a second depth so that the first depth plus the second depth is greater than the thickness of the substrate. The fiber retaining groove on the one side is oriented relative to the vent groove on the opposite side so that the vent groove cross cuts or intersects into the fiber retaining rove to provide a vent hole at the point of intersection between the two grooves. The vent hole provides for the egress of any excess adhesive or air that becomes trapped between the optical fiber and the fiber retaining groove during assembly. The vent thereby functions to deter the formation of voids between the fiber and the walls of the first groove.

This application claims the benefit of co-pending U.S. Provisional Application Serial No. 60/288,231, filed May 1, 2001, such application being incorporated herein by reference.

### FIELD OF THE INVENTION

The present invention related generally to fiber optic devices, and in particular to devices having grooves for retaining optical fibers wherein the grooves include vent holes.

### BACKGROUND

Optical microbenches are micromachined substrates adapted to serve as fixtures for optical fibers, lenses, lasers, detectors and the like. To attach optical fibers to the microbench, the optical fibers are positioned in V-shaped or U-shaped grooves in the substrate, adhesive is applied, and the assembly is cured. However, voids are often created in the gaps between the fiber and the base of the groove thereby degrading optical performance. The problem is exacerbated when the fibers are sandwiched between two substrates, such as an optical microbench and a lid. While the source is not completely understood, these voids may be caused by: gas generation during adhesive cure; dewetting; an inability of the applied adhesive to displace the air occupying the volume between the fiber and the base of the groove due to tight sealing between the fiber and the walls of the groove; or an adhesive flow insufficient to displace all of the column of air between the fiber and the walls of the groove during the time between adhesive application and cure. The presence of such voids can also unacceptably weaken the strength of the fiber-to-substrate bond creating low production yields. Thus, it would be desirable to produce microbenches that are not susceptible to the formation of voids between the fiber and the microchip.

### SUMMARY

In accordance with the present invention, an optical microbench is provided comprising a substrate. At least one optical element retaining feature is disposed within the substrate along a first surface of the substrate for holding an optical fiber in position relative to the substrate. The optical element retaining feature may take the form of at least one groove, such as a V-shaped optical retaining groove, disposed along the first surface of the substrate and adapted to retain the optical fiber. At least one vent passageway in the form of a vent channel, for example, is disposed within the substrate in position to intersect the optical element retaining feature to provide a vent on the optical element retaining feature at the place of intersection between the passageway and the optical element retaining feature. The channel may take the form of a vent groove disposed along a second surface of the substrate such as a surface overlaying or underlying the first surface of the substrate. The vent groove on the one side of the substrate is positioned and dimensioned relative to the optical retaining groove on the other side of the substrate to permit the intersection of the vent groove with the optical retaining groove. The vent groove is dimensioned with sufficient depth to cut at least partially into the optical retaining groove to provide an opening at the cross-cut locations of intersection. The vent groove may also be oriented longitudinally relative to the optical retaining groove but with sufficient depth to provide a vent opening between the grooves at overlapping locations.

In a specific configuration, an optical microbench comprises a substrate of a selected thickness having a first side and a second generally opposite side. The first side includes at least a first groove having a first depth into the thickness of the substrate. The second side includes at least a second groove having a second depth into the thickness of the substrate. The first groove on the first side is positioned to intersect or crisscross the second groove on the second side. The first depth plus the second depth is greater than the thickness of the substrate, so that wherever the second groove intersects the first groove an access opening is provided between the two grooves so that the second groove communicates with the first groove through the opening. As such, the intersection of the first and second grooves provides a vent hole between the two grooves. When an optional fiber is positioned within the first groove and an adhesive is applied, any trapped air or excess adhesive may be expelled through the vent into the second groove.

### BRIEF DESCRIPTION OF THE DRAWINGS

The foregoing summary and the following detailed description of the preferred embodiments of the present invention will be best understood when read in conjunction with the appended drawings, in which:

FIG. 1 schematically illustrates a bottom side view of an optical microbench with a vent groove on the bottom side of a substrate having sufficient depth to intersect fiber grooves shown in phantom on the other side of the substrate to create vent holes at the points of intersection;

FIG. 2 schematically illustrates an end elevational view of the optical microbench of FIG. 1;

FIG. 3 schematically illustrates an isometric view of the optical microbench of FIG. 1;

FIG. 4 schematically illustrates a bottom side view of an optical microbench with a vent groove on the bottom side of the microbench having a 15 depth sufficient to intersect fiber grooves (shown in phantom) on the other side of the microbench so that vent holes are provided at the points of intersection, but wherein the vent groove does not extend to the outer edges of the substrate;

FIG. 5 schematically illustrates an end elevational view of the optical microbench of FIG. 4; and

FIG. 6 schematically illustrates an isometric view of the optical microbench of FIG. 4.

### DETAILED DESCRIPTION OF THE PREFERRED EMBODIMENTS

In accordance with the present invention, an optical microbench 10, made of a substrate 24 of (100)-oriented silicon, for example, is provided having a predetermined thickness. The optical microbench 10 includes at least one fiber groove 12 formed in a first surface 25 of the substrate 24 adapted to receive an optical fiber. Additional fiber grooves 13, 14, 15, 16 may be included to provide a fiber array in the optical microbench 10. Vent holes (or bleed holes) 17, 18, 19, 20, 21 are provided at the base of the fiber grooves 12, 13, 14, 15, 16. The vent holes 17, 18, 19, 20,21 are formed, for example, by creating at least one vent groove on a second reverse surface 26 of the substrate 24 disposed generally on an opposite side of the substrate relative to the first surface 25 of the substrate 24. The vent groove 11 is configured to intersect the bottom of the fiber grooves 12, 13, 14, 15, 16, to form vent holes 17, 18, 19, 20, 21 between the vent groove 11 and the respective fiber grooves 12, 13, 14, 15, 16 on the other side of the substrate. For this purpose, the vent groove 11 is disposed on one surface of the substrate in position to crisscross the fiber grooves 12, 13, 14, 15, 16 on the other surface of the substrate. Furthermore, the vent groove 11 has sufficient depth relative to the fiber grooves 12, 13, 14, 15, 16 to at least partially cross cut into the base of the respective fiber grooves 12, 13, 14, 15, 16 to form the vent holes 17, 18, 19, 20, 21 at the base of the respective fiber grooves 12, 13, 14, 15, 16. The geometry of the intersecting vent groove 11 and the respective fiber grooves 12, 13, 14, 15, 16 may be configured to assure that the vent holes 17, 18, 19, 20, 21 will be centered at the base of the fiber grooves 12, 13, 14, 15, 16. The vent holes 17, 18, 19, 20, 21 function to enable venting of both air and excess adhesive from the space between the fibers and the base of the respective fiber grooves 12, 13, 14, 15, 16. A plurality of vent holes may be provided along the length of each fiber groove 12, 13, 14, 15, 16 by providing additional vent grooves.

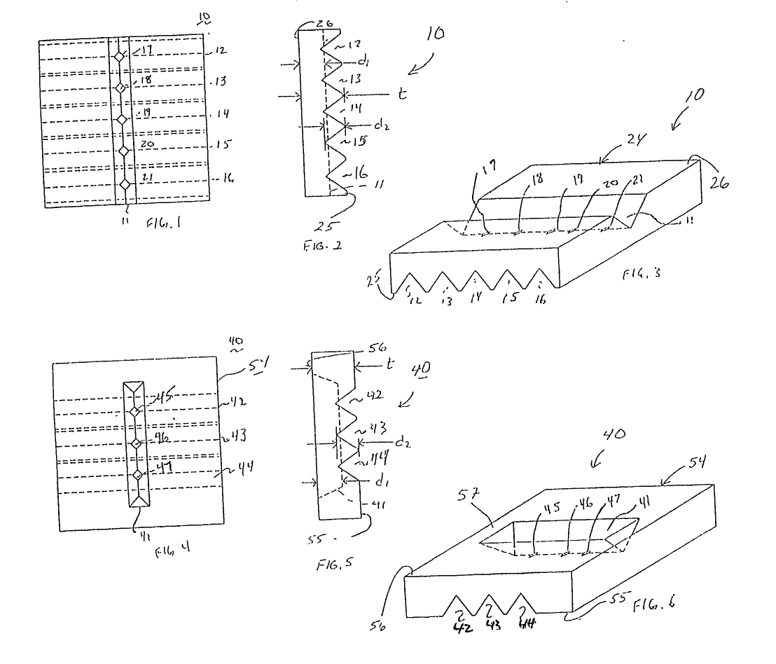

Turning now to the drawings, where like reference numerals refer to like elements throughout, FIGS. 1, 2 and 3 depict an optical microbench 10 having an array of fiber grooves 12, 13, 14, 15, 16 disposed in generally parallel relationship on a first surface 25 of the substrate 24. While the fiber grooves 12, 13, 14, 15, 16 are shown to be oriented in generally parallel relationship, the fiber grooves 12, 13, 14, 15, 16 need not be parallel to one another.

A vent groove 11 is disposed in a second surface 26 of the substrate 24 generally on the opposite side of the substrate relative to the first surface 25 of the substrate 24. The fiber grooves 12, 13, 14, 15, 16 and/or the vent groove 11 may be in the form of V-shaped grooves, as best depicted in FIGS. 2 and 3. Alternatively, the fiber grooves 12, 13, 14, 15, 16 and/or the vent groove 11 may have other shapes suited to retaining optical fibers, such as U-shaped grooves or truncated V-shaped grooves. The vent groove 11 and fiber grooves 12, 13, 14, 15, 16 need not have the same shape.

As best shown in FIG. 1, the vent groove 11 has a longitudinal axis that is oriented perpendicular to the longitudinal axes of the fiber grooves 12, 13, 14, 15, 16. More generally, the vent groove 11 may be oriented relative to the fiber grooves to ensure that the vent groove intersects one or all of the fiber grooves 12, 13, 14, 15, 16 as desired. The vent groove may be dimensioned and positioned to intersect some or all of the fiber grooves. Furthermore, the longitudinal axis of the vent groove need not be perpendicular to the longitudinal axes of the fiber grooves but may instead be oriented at an angle with respect to one or all of the fiber grooves. To ensure adequate venting of all the fiber grooves, the angle of orientation between the vent grooves and the fiber grooves should be chosen so that a vent hole is provided in each of the fiber grooves 12, 13, 14, 15, 16. A vent groove may also be oriented generally parallel to a fiber groove so as to intersect the fiber groove along a selected length of the fiber groove to form a longitudinally extending vent hole. In addition, a separate vent groove, or a separate series of vent grooves, may be provided along the longitudinal axis of each fiber groove to provide a longitudinally extending vent hole, or a series of longitudinally extending vent holes, along each fiber groove.

Referring again to FIGS. 1-3, the vent groove 11 extends into the substrate 24 from the second surface 26 a distance, d₁, that is sufficiently deep relative to the fiber grooves to enable the vent groove 11 to intersect and communicate with the fiber grooves 12, 13, 14, 15, 16. The intersection of the vent groove 11 and fiber grooves 12, 13, 14, 15, 16 provides vent holes 17, 18, 19, 20, 21 in the fiber grooves 12, 13, 14, 15, 16, as best seen in FIGS. 1 and 3. The intersection between the vent groove 11 and fiber grooves 12, 13, 14, 15, 16 may be created when the depth, d₂, of the fiber grooves 12, 13, 14, 15, 16 from the first surface 25 into the substrate 24 plus depth, d₁, of the vent groove 11 from the second surface 26 into the substrate 24 exceeds the thickness, t, of the substrate 24 measured between the first surface 25 and the second surface 26, as best seen in FIG. 2.

In a specific configuration, the substrate 24 may be a silicon wafer which is typically about 500 microns thick. The fiber grooves 12, 13, 14, 15, 16 may be on the order of about 50 microns deep. If, for example, the vent groove 11 is provided at 460 microns deep the combined depth of one of the fiber grooves 12, 13, 14, 15, 16 and the vent groove 11 will be almost 510 microns. Accordingly, the combined depth of the vent groove 11 and a fiber groove will exceed the thickness of the substrate by 10 microns thereby creating vent holes 17, 18, 19, 20, 21 about 10 microns deep at the base of the fiber grooves 12, 13, 14, 15, 16. While each of the fiber grooves 12, 13, 14, 15, 16 is depicted in FIGS. 2 and 3 as having equal depth, the fiber grooves may have differing depths so long as each fiber groove 12, 13, 14, 15, 16 is deep enough relative to the depth of the vent groove to communicate with the vent groove 11 at any desired points of intersection. In certain applications, however, the depth of an otherwise intersecting vent groove may be selected relative to the depth of a 15 particular fiber groove to avoid cutting into such fiber groove at a particular location to prevent the formation of a vent hole at such location.

Referring now to FIGS. 4-6, an optical microbench 40 in accordance with another embodiment is depicted. The microbench 40 comprises a substrate 54 having a vent groove 41 disposed in a second surface 56 of the substrate 54 wherein the vent groove 41 does not extend to the outer edges of the substrate thereby providing a mechanically reinforcing “frame” 57 of substrate 54 around the periphery of the substrate and the vent groove 41. Three fiber grooves 42, 43, 44 are disposed in generally parallel relationship in a first surface 55 of the substrate 54. The grooves 42, 43, 44 are formed on a surface generally opposite the second surface 56 of the substrate 54. The fiber grooves 42, 43, 44 and the vent groove 41 can take the form of V -shaped grooves, as depicted in FIGS. 4-6, or other shapes suitable for retaining optical fibers within the fiber grooves, such as U-shaped grooves, truncated V-shaped grooves or other suitable shapes. The vent groove 41 and the fiber grooves 42, 43, 44 need not all have the same shape.

The vent groove 41 extending into the substrate 54 from the second surface 56 a distance, d₁, that is sufficiently deep to intersect arid communicate with the fiber grooves 42, 43, 44. The intersection of the vent groove 41 and fiber grooves 42, 43, 44 provides vent holes 45, 46, 47 within the fiber grooves 42, 43, 44, as shown in FIGS. 4 and 6. The intersection between the vent groove 41 and the respective fiber grooves 42, 43, 44 can be effected when the depth, d₂, of the fiber grooves 42, 43, 44 into the substrate 54 from a first surface 55 of the substrate 54 plus the depth, d₁, of the vent groove 41 into the substrate 54 from the surface 56 exceeds the thickness, t, of the substrate 54 measured between the first surface 55 and the second surface 56, as best seen in FIG. 5.

The fiber grooves and vent grooves of the above embodiments can be provided by conventional molding, micromachining, milling, and/or etching processes. For example, the substrate 24, 54 may comprise a silicon wafer which may be etched by a variety of techniques, such as anisotropic etching. In particular (100)-oriented silicon may be etched by potassium hydroxide to, provide V-shaped or U-shaped grooves to serve as the fiber grooves 12, 13, 14, 15, 16, 42, 43, 44 and/or the vent grooves 11,41. In addition, the vent grooves 11, 41 may be created by angle dice sawing. The vent grooves 11,41 or the fiber grooves 12, 13, 14, 15, 16, 42; 43, 44 may be formed first. In general, the substrate 24, 54 may be formed of any material which permits the inclusion of fiber grooves 12, 13; 14, 15, 16, 42, 43, 44 and vent grooves 11, 41 in the substrate 24, 54. Such materials include. but are not limited to, glass, plastics, ceramics, and metals.

In one aspect of the invention, a silicon wafer substrate is created with an oxide film on the surface of the fiber grooves prior to etching the vent grooves. The oxide film may be provided by conventional methods such as by—thermal oxidation; for example. The vent groove etch ant is selected to be substantially non-reactive with the oxide film. As a result, the oxide film will prevent blow-through, that is, the undesirable etching of the fiber groove surfaces when the vent hole is created. When the vent holes are formed by etching of the vent groove, any leakage of etchant through the vent holes and into the fiber grooves will not erode or etch the fiber grooves, because the non-reactive oxide film will function to protect the fiber grooves from any such inadvertent etching. The oxide film may be removed after vent groove etching using hydrofluoric acid, for example. Alternative coatings and techniques for preventing blow-through are described in U.S. Pat. No. 5,338,400, issued Aug. 16; 1994, which is incorporated herein by reference as if set forth in full.

As an alternative process, the vent groove 11, 41 may be formed in the substrate 24; 54 and an oxide film applied over the vent groove 11; 41. Subsequently, the fiber grooves 12, 13, 14, 15, 16, 42, 43, 44 may be etched using an etchant which is substantially non-reactive to the oxide film on the vent groove 11, 41. In this case, the presence of the oxide film on the vent groove 11, 41 will prevent blow-through as the fiber grooves 12, 13, 14, 15, 16, 42, 43, 44 are etched.

In use, an optical microbench of the present invention may be assembled with optical fibers, adhesive, and a lid to form a device for retaining one or more optical fibers, such as a one-dimensional fiber array. The adhesive may be applied into the fiber groove and the fiber laid into such groove. Pressure may then be applied to the fiber to press the fiber into the fiber groove. Any excess adhesive or air may exit the fiber groove through the vent hole in the fiber groove. The pressure on the fiber may be applied using the lid. The lid may be 10 flat and formed of any of the materials suitable for the substrate. For example the lid may be formed of borosilicate glass. Alternatively, the lid may be a second optical microbench with complementary fiber grooves configured for mating with the first optical microbench. Likewise the lid may be substantially identical to the optical microbench to which it is applied.

The optical micro bench may also be fitted with additional features to provide for the mounting of additional optical elements on the microbench, such as lenses, lasers, detectors and the like. For example, grooves, recessed areas, or other mounting features may be provided for holding optical elements other than fibers. One or more vent grooves may be provided which intersect the grooves, recessed areas, or other mounting features to provide vent holes therein in the same manner described above. Moreover, a single vent groove may simultaneously communicate with a fiber groove as well as with other optical element mounting features, to provide respective vent holes for an optical fiber and a variety of other optical elements.

These and other advantages of the present invention will be apparent to those skilled in the art from the foregoing specification. Accordingly, it will be recognized by those skilled in the art that changes or modifications may be made to the above-described embodiments without departing from the broad inventive concepts of the invention. For example, while the above embodiments show the vent and fiber grooves disposed on opposing sides of the substrate, the vent and fiber grooves may be provided on adjoining or other cooperating sides or surfaces of the substrate. Moreover, while the vent holes are formed by vent grooves in a surface of the substrate, the vent holes may also be formed by the intersection of fiber grooves with channels, passageways or even tunnels extending through the body of the substrate. For example, the microbench may include fiber grooves on opposite sides of a substrate which do not directly intersect each other, and one or more vent channels may be provided in the body of the substrate to provide vent holes in the fiber channels. Such a configuration would be particularly suited to the creation of a stacked two-dimensional fiber array. It should therefore be understood that this invention is not limited to the particular embodiments described herein, but is intended to include all changes and modifications that are within the scope and spirit of the invention as set forth in the claims.

What is claimed is:

1. An article of manufacture, an optical microbench comprising:
a substrate having a first side, a second side and a thickness; the first side having at least one first groove having a first depth; and
the second side having at least one second groove having a second depth, wherein the second groove intersects the first groove, and wherein the first depth plus the second depth is greater than the thickness of the substrate.

2. The optical microbench of claim 1, comprising at least one optical fiber in the at least one first groove and affixed therein by an adhesive.

3. The optical microbench of claim 1, wherein the intersection of the first groove and the second groove forms a vent hole so that the first groove communicates with the second groove.

4. The optical microbench of claim 1, wherein the first side of the substrate is disposed generally opposite the second side of the substrate.

5. The optical microbench according to claim 1, wherein the substrate comprises silicon.

6. An optical microbench, comprising:
a substrate having a first surface;
at least one optical element retaining feature disposed within the first surface of the substrate;
at least one passageway disposed within the substrate, the passageway intersecting the optical element retaining feature to provide a vent opening at the intersection of the passageway and the optical element retaining feature.

7. The optical microbench according to claim 6, wherein the optical element retaining feature comprises a groove.

8. The optical microbench according to claim 7, wherein the groove is adapted to receive an optical fiber.

9. The optical microbench according to claim 6, wherein the at least one optical element retaining feature comprises a plurality of grooves.

10. The optical microbench according to claim 6, wherein the substrate comprises a second surface and the passageway comprises a groove disposed at the second surface.

11. The optical microbench according to claim 10, wherein the second surface is disposed generally opposite the first surface.

12. The optical microbench according to claim 6, wherein the at least one optical element retaining feature comprises a plurality of optical element retaining features.

13. The optical microbench according to claim 6, wherein the at least one passageway comprises at least one channel.

14. The optical microbench according to claim 6, comprising an optical fiber disposed in the optical element retaining feature.

15. The optical microbench according to claim 6, wherein the substrate comprises silicon.

16. The optical microbench according to claim 6 wherein the optical element retaining feature includes at least one groove disposed along the first surface dimensioned to receive an optical fiber and wherein the passageway includes at least one groove disposed along the second surface and oriented to cut into the groove of the optical element retaining retaining feature to form the vent.
